(19) United States
(12) Patent Application Publication
(10) Pub. No.: US 2016/0121378 A1
(43) Pub. Date: May 5, 2016

(54) Tube Cleaning Dart

(71) Applicant: National Heat Exchange Cleaning Corporation, Columbiana, OH (US)

(72) Inventors: Brian D. Antal, Fombell, PA (US); Carroll E. Joseph, Leetonia, OH (US)

(21) Appl. No.: 14/528,463

(22) Filed: Oct. 30, 2014

(51) Int. Cl. B08B 9/055

(52) U.S. Cl. CPC B08B 9/055; B08B 9/0552

(57) ABSTRACT

A dart assembly for cleaning tubes that includes a plug with a shaft having a first end and a second end and a scraper extending laterally from the shaft and a flexible, compressible ball attached to the second end of the plug. Also, a method of cleaning a tube. A dart assembly as previously described is inserted into the inner diameter of the tube, and the dart assembly is forced through the tube using pressurized fluid. The first end of the dart assembly may be inserted into the tube first such that the interior surface of the tube is first contacted by the scraper and then contacted by the ball as the dart assembly is forced through the tube.

### BACKGROUND OF THE INVENTION

1. Field of the Invention

The present invention relates to a tube cleaning apparatus and a method of cleaning a tube using the tube cleaning apparatus, more particularly, to a dart assembly used to clean heat exchanger and condenser tubing or piping and a method of cleaning heat exchanger and condenser tubing or piping using the dart assembly.

2. Description of Related Art

Many heat exchangers utilize water or other liquids passing through tubes. Water sources passing through the tubes present many problems, such as deposits and obstructions that limit the heat transfer and life expectancy of the tubing. Slime, sticks, mud, shells, calcium carbonate scale, and manganese scale are just some examples of materials that can deposit in or obstruct heat exchanger tubes.

Tube cleaning assemblies have been developed to aid in the removal of the obstructions and deposits. Typically, these tube cleaning assemblies include a fin or blade arrangement attached to a body. The tube cleaning assembly is placed at one end of the tube to be cleaned with the fins in contact with an inner surface of the tube. High pressure water is forced through the tube and pushes the tube cleaning assembly through the tube, scraping the inner surface and removing obstructions and deposits along the way until the tube cleaning assembly exits the tube.

These scraper-type assemblies can be very efficient at removing certain types of deposits and obstructions. However, the deposits and obstructions in the tube can vary and can include a mixture of different types of deposits and obstructions. It is therefore desirable to have a tube cleaning assembly that includes more than one means for cleaning the tube.

### SUMMARY OF THE INVENTION

The present invention is directed to a dart assembly for cleaning tubes. The dart assembly includes a plug including a shaft having a first end and a second end and a scraper extending laterally from the shaft and a flexible, compressible ball attached to the second end of the plug. The first end of the shaft may be closed and rounded, and the shaft may have a generally circular cross-section. A flange may extend circumferentially around the second end of the shaft.

The scraper may be an annular ring and may include a plurality of segments with slots extending between adjacent segments. The outer edge of the scraper may be curved to correspond to the curved inner surface of the tube that is to be cleaned.

The ball may be generally spherical in shape and, in an uncompressed state, may have a width at its widest point when measured in a direction perpendicular to a longitudinal axis of the dart that is greater than the width of the scraper at its widest point when measured in a direction perpendicular to the longitudinal axis of the dart. The ball may be made of sponge foam rubber and may be attached to the plug using adhesive. The ball may have an abrasive material on all, a portion of, or none of its exterior surface. The abrasive material may be carbonite, corundum, and plastic granulate.

The present invention is also directed to a method of cleaning a tube. A dart assembly as described above is inserted into the inner diameter of the tube, and the dart assembly is forced through the tube using pressurized fluid. The fluid may be at a pressure of 100 to 450 psi. The first end of the dart assembly may be inserted into the tube first, such that the interior surface of the tube is first contacted by the scraper and then contacted by the ball as the dart assembly is forced through the tube.

### BRIEF DESCRIPTION OF THE DRAWING(S)

FIG. 1 is a side perspective view of a dart assembly according to the present invention;

FIG. 2 is a perspective view of the dart assembly of FIG. 1 as viewed from the first end; and

FIG. 3 is a side elevational view, partially in section, of the dart assembly of FIGS. 1 and 2 inserted into a tube.

### DESCRIPTION OF THE INVENTION

The present invention is directed to a dart assembly for cleaning a tube such as a heat exchanger tube. The dart assembly 10 is inserted in the tube to be cleaned and pushed through the tube 36 using a pressurized fluid such as water, air, or gas. The dart assembly 10 includes a plug 12 attached to a ball 14.

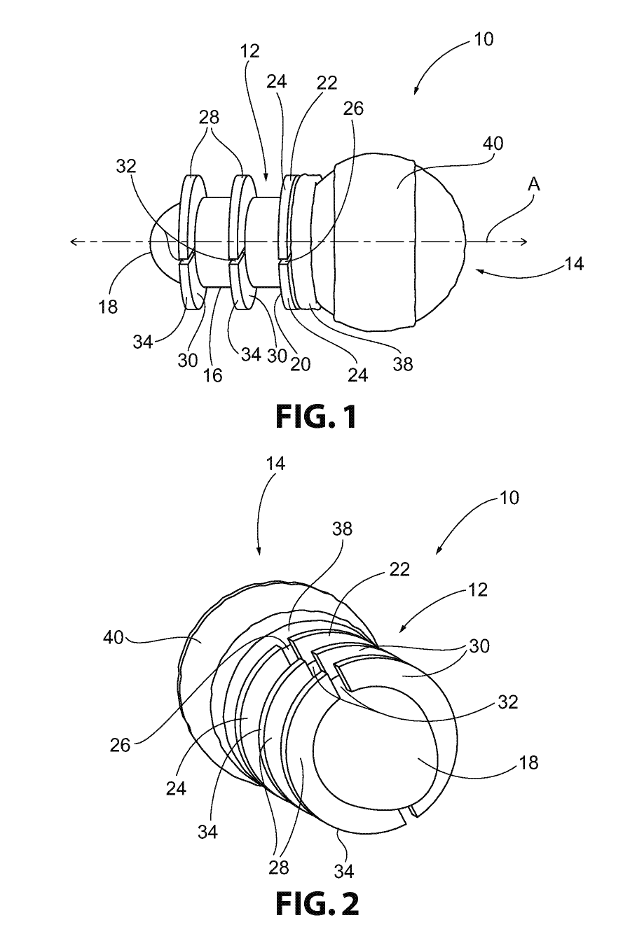

The plug 12 has a shaft 16. The shaft 16 may have a cross-section that is generally circular as shown in FIGS. 1-3 or may have any suitable cross-section including, but not limited to, oval, triangular, square, rectangular, and polygonal. The shaft 16 may be hollow or may be solid. The shaft 16 has a first end 18 and a second end 20. The first end 18 is closed and may be rounded as shown in FIGS. 1-3. The first end 18 may take the shape of a hemisphere.

The second end 20 may be open or closed and has a flat surface. A flange 22 may extend circumferentially around the second end 20 of the shaft 16. The flange 22 may have a plurality of segments 24 with a slot 26 extending between adjacent segments 24. While two segments 24 spaced 180° apart are shown in FIGS. 1-3, the flange 22 may include any number of segments 24.

A fin-shaped scraper 28 extends laterally outward from the perimeter of the shaft 16. Any number of scrapers 28 may be provided, for example, one, two, three, or more. The scraper 28 may be an annular ring as shown in FIGS. 1-3. The scraper 28 may include a plurality of segments 30 with slots 32 extending between adjacent segments 30. While two segments 30 spaced 180° apart are shown in FIGS. 1-3, the scraper 28 may include any number of segments 30. The outer edge 34 of the scraper 28 may be curved to correspond to the curved inner surface of the tube 36 tube that is to be cleaned. The width of the scraper 28 at its widest point when measured in a direction perpendicular to the longitudinal axis A of the dart 10 is equal to or just slightly larger than the inner diameter of the tube 36 that is to be cleaned so that, when the dart assembly 10 is placed inside of the tube 36 to be cleaned, an interference fit will be created between the scraper 28 and the inner surface of the tube 36. For example, the difference between the width of the scraper 28 and the inner diameter of the tube 36 may be on the order of several thousands of an inch. In this manner, when the dart assembly 10 is inserted into the tube 36, the segments 30 of the scraper 28 will flex and be in contact with the inner surface of the tube 36 applying a scraping force thereto. As the dart assembly 10 passes through the tube 36, the segments 30 of the scraper 28 are able to remove deposits from the interior surface of the tube 36.

The plug 12 may be made from a rigid plastic such as low density or high density polyethylene.

The ball 14 is attached to the second end 20 of the shaft 16. The ball 14 is generally spherical in shape and is made of a flexible, compressable material including, but not limited to, sponge foam rubber. In the uncompressed or relaxed state, the ball 14 has a width at its widest point when measured in a direction perpendicular to the longitudinal axis A of the dart 10 that may be greater than the width of the scraper 28 at its widest point when measured in a direction perpendicular to the longitudinal axis A of the dart 10 and is larger than the inner diameter of the tube 36 that is to be cleaned. When the dart assembly 10 is placed inside of the tube 36 to be cleaned, the ball 14 will slightly compress because its width is larger than the diameter of the tube 36. This compression creates an interference fit between the ball 14 and the inner surface of the tube 36. As a result, as the dart assembly 10 passes through the tube 36, the exterior surface of the ball 14 is in good contact with the interior surface of the tube 36 and is therefore able to clean deposits from the interior surface of the tube 36.

The ball 14 may be attached to the plug 12 using any suitable method including, but not limited to, adhesive 38 and mechanical fastening.

The ball 14 may have an abrasive material on all or a portion of its exterior surface. For example, as shown in FIGS. 1-3, the ball 14 may have a ring of abrasive material 40 around its circumference. The ring of abrasive material 40 is positioned on the outer surface of the ball 14 at its widest point when measured in a direction perpendicular to the longitudinal axis A of the dart 10 and corresponds with the outer edge 34 of the scraper 28. In this way, the interior of the tube 36 is first cleaned by the scraper 28 and then cleaned by the abrasive material 40 on the ball 14, acting as an additional scraper, as the dart assembly 10 passes through the tube 36. The abrasive material 40 includes, but is not limited to, carbonite, corundum, and plastic granulate.

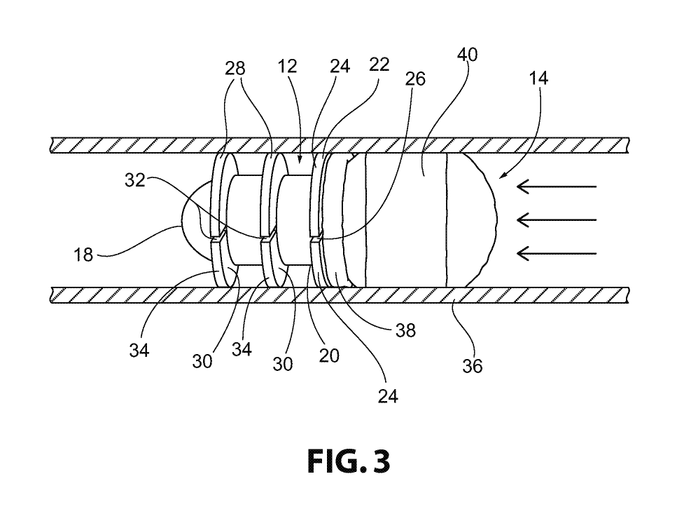

A shown in FIG. 3, in use, the dart assembly 10 is inserted into the tube 36 that is to be cleaned with the first end 18 being inserted into the tube 36 first. A high pressure fluid, such as water, air, or gas, is then supplied to the tube 36 such that it impinges the ball 14. The direction of the fluid flow is shown by the arrows in FIG. 3. The pressurized fluid may be at a pressure of 100 to 450 psi. The fluid pressure forces the dart assembly 10 through the tube 36 toward the exit end with a portion of fluid passing through the ball 14 and the slots 26 between the segments 24 of the flange 22 and the slots 32 between the segments 30 of the scraper 28. The scraper 28 and the ball 14 remove deposits from the inner surface of the tube 36 which are then pushed along by the scraper 28 and/or the ball 14 or are carried by the fluid. After the dart assembly 10 exits the tube 36, the process can be repeated on another tube 36.

Although the invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A dart assembly for cleaning tubes comprising:
a plug comprising a shaft having a first end and a second end and a scraper extending laterally from the shaft; and
a flexible, compressible ball attached to the second end of the plug.

2. The dart assembly of claim 1, wherein the shaft has a cross-section that is generally circular.

3. The dart assembly of claim 1, wherein the first end of the shaft is closed and rounded.

4. The dart assembly of claim 1 further comprising a flange extending circumferentially around the second end of the shaft.

5. The dart assembly of claim 1, wherein the scraper is an annular ring.

6. The dart assembly of claim 1, wherein the scraper comprises a plurality of segments with slots extending between adjacent segments.

7. The dart assembly of claim 1, wherein the outer edge of the scraper is curved to correspond to the curved inner surface of the tube that is to be cleaned.

8. The dart assembly of claim 1, wherein the ball is generally spherical in shape.

9. The dart assembly of claim 1, wherein the ball is made of sponge foam rubber.

10. The dart assembly of claim 5, wherein, in an uncompressed state, the ball has a width at its widest point when measured in a direction perpendicular to a longitudinal axis of the dart that is greater than the width of the scraper at its widest point when measured in a direction perpendicular to the longitudinal axis of the dart.

11. The dart assembly of claim 1, wherein the ball is attached to the plug using adhesive.

12. The dart assembly of claim 1, wherein the ball has an abrasive material on all or a portion of its exterior surface.

13. The dart assembly of claim 12, wherein the abrasive material is one of carbonite, corundum, and plastic granulate.

14. A method of cleaning a tube comprising:
inserting a dart assembly into the inner diameter of the tube; and
forcing the dart assembly through the tube using pressurized fluid,
wherein the dart assembly comprises:
a plug comprising a shaft having a first end and a second end and a scrapers extending laterally from the shaft; and
a flexible, compressible ball attached to the second end of the plug.

15. The method of claim 14, wherein pressurized fluid at a pressure of 100 to 450 psi is used to force the dart assembly through the tube.

16. The method of claim 14, wherein the scraper is an annular ring and at least one of the ball in an uncompressed state and the scraper have a width at the widest point when measured in a direction perpendicular to the longitudinal axis of the dart that is greater than an inner diameter of the tube.

17. The method of claim 14, wherein the first end of the dart assembly is inserted into the tube first such that the interior surface of the tube is first contacted by the scraper and then contacted by the ball as the dart assembly is forced through the tube.

18. The method of claim 14, wherein the scraper comprises a plurality of segments with slots extending between adjacent segments.

19. The method of claim 14, wherein the ball has an abrasive material on all or a portion of its exterior surface.
